(19) United States
(12) Patent Application Publication
(10) Pub. No.: US 2012/0069340 A1
(43) Pub. Date: Mar. 22, 2012

(54) FLOW CELL EXPLOITING RADIATION WITHIN CELL WALL

(75) Inventor: Beno Mueller, Ettlingen (DE)

(73) Assignee: AGILENT TECHNOLOGIES, INC., Santa Clara, CA (US)

(21) Appl. No.: 13/321,193

(22) PCT Filed: May 20, 2009
(86) PCT No.: PCT/EP2009/056121

§ 371 Date: Nov. 18, 2011

(51) Int. Cl. G01N 21/59; G01N 21/05; G01J 1/42

(52) U.S. Cl. 356/440; 250/373

(57) ABSTRACT

A flow cell (200) for a sample separation apparatus (10) for separating components of a sample fluid in a mobile phase, the flow cell (200) being configured for detecting the separated components and comprising a tubing (202) having an inner wall (204) and an outer wall (206), the inner wall (204) defining a lumen (208) for conducting the sample fluid, the tubing (202) further having at one end an end face (210), and a detection unit (212) configured for detecting electromagnetic radiation (214) exiting the end face (210) after propagation of the electromagnetic radiation (214) through the sample fluid in a portion of the lumen (208) and through a portion of the tubing (202) between the inner wall (204) and the outer wall (206).

### BACKGROUND ART

The present invention relates to a flow cell.

In liquid chromatography, a fluidic analyte may be pumped through conduits and a column comprising a material which is capable of separating different components of the fluidic analyte. Such a material, so-called beads which may comprise silica gel, may be filled into a column tube which may be connected to other elements (like a control unit, containers including sample and/or buffers) by conduits.

When a fluidic sample is pumped through the column tube, it is separated into different fractions. The separated fluid may be pumped in a flow cell in which the different components are identified on the basis of an optical detection mechanism.

U.S. Pat. No. 6,108,083 discloses a spectroscopic system for the analysis of small quantities of substances which makes use for the purposes of energy transfer of cone-shaped aperture changers which are arranged in the object zone between the light source and the sample and, during absorption measurements, also between the sample and the inlet slot of a spectrometer. A microcell system is provided in the object space. The microcell system comprises a cylindrical cell tube with a hollow core for receiving a sample liquid. The cell tube and the sample liquid being adjustable with respect to the refractive index such that they act as a step waveguide for radiation, the sample liquid forming the core and the wall of the cell tube forming the sheath of the step waveguide.

WO 2007/009492, filed by the same applicant Agilent Technologies, discloses a method of coupling at least two conduits for bringing them in communication. Each of the conduits is configured for conducting a medium and has an outlet and an outer surface adjacent to the outlet. The outer surfaces and a solid plastic material are at least partly inserted into an aperture of a coupling element. The plastic material is plastified and/or melted at least partly. The plastic material is solidified for sealing and fixing the conduits within the aperture of the coupling element.

Conventional detection cells may require a relatively long optical path length of light travelling through a fluidic capillary along which a separated fluidic sample flows to provide a sufficient detection accuracy. Long path lengths of propagating electromagnetic radiation acting as a probe for fractions of the fluidic sample may also result in relatively large losses of light intensity due to absorption, reflection into non-usable spatial portions of a detection cell, etc. Consequently, the signal to noise ratio and therefore the detection accuracy of conventional detection cells may be not large enough, particularly in view of the trend that dimensions of a flow cell continue to decrease.

### DISCLOSURE

It is an object of the invention to provide a flow cell having a sufficiently high detection accuracy. The object is solved by the independent claims. Further embodiments are shown by the dependent claims.

According to an exemplary embodiment of the present invention, a flow cell for a sample separation apparatus for separating components of a sample fluid in a mobile phase is provided, the flow cell being configured for detecting the separated components and comprising a tubing having an inner wall and an outer wall, the inner wall defining a lumen for conducting the sample fluid, the tubing further having at one end an end face (particularly at an end of a propagation path of the electromagnetic radiation along the tubing, i.e. an end of the tubing facing a detection unit and opposing an electromagnetic radiation source), and a detection unit configured for detecting electromagnetic radiation exiting the end face after propagation of the electromagnetic radiation through the sample fluid in a portion of the lumen and through a portion of the tubing between the inner wall and the outer wall.

According to another exemplary embodiment, a sample separation apparatus for separating components of a sample fluid in a mobile phase is provided, the sample separation apparatus comprising a separation unit configured for separating the sample fluid into the components, and a flow cell having the above mentioned features and being in fluid communication with the separation unit for receiving the separated sample fluid from the separation unit and configured for detecting the separated components.

According to still another exemplary embodiment, a method of detecting separated components of a sample fluid in a mobile phase is provided, wherein the method comprises conducting the separated sample fluid through a lumen of a flow cell comprising a tubing having an inner wall and an outer wall, the inner wall defining the lumen, the tubing further having at one end an end face, and detecting electromagnetic radiation exiting the end face after propagation of the electromagnetic radiation through the sample fluid in a portion of the lumen and through a portion of the tubing between the inner wall and the outer wall.

According to an exemplary embodiment, a flow cell for a liquid chromatography apparatus or the like may be provided which has a high yield regarding detected electromagnetic radiation. This increased yield may result from the fact that exemplary embodiments may use electromagnetic radiation which has travelled partially along a fluidic part and partially within a wall of a tubing. Since such electromagnetic radiation has also “seen” the sample in the portion of travelling through the lumen, also this radiation can be used as a powerful probe for providing information regarding separated fractions of the sample, since these fractions have an impact on the absorption characteristic of the radiation beam as well. Exemplary embodiments of the invention may ensure that light which travels entirely through the wall of the tubing without travelling at least partially along the lumen and therefore through the sample fluid is safely prevented from being detected because this electromagnetic radiation only contributes to the noise and not the use signal. The suppression of corresponding artifacts can be achieved by coupling the light into the flow cell in such a manner that a direct coupling along a front face of the tubing is prevented. Exemplary embodiments may therefore also use radiation which leaves the end face of a tubing while ensuring that this radiation has not been coupled into the tubing right from the beginning of its propagation path, but only after having traversed a section of the sample.

In the following, further exemplary embodiment of the flow cell will be explained. However, these embodiments also apply to the sample separation apparatus and the method.

In an embodiment, the detection unit may be configured for additionally detecting electromagnetic radiation after propagation entirely through the sample fluid in the lumen without propagating through the tubing between the inner wall and the outer wall. Therefore, the yield may be further increased by not only detecting electromagnetic radiation having partially travelled through the lumen and partially through the tubing, but also taking into account electromagnetic radiation which has travelled entirely along the lumen without travelling through the tubing.

In an embodiment, the detection unit may be configured for detecting the electromagnetic radiation after propagation partly through the sample fluid in the lumen and partly through the tubing and exiting via the end face of the tubing between the inner wall and the outer wall, the end face facing directly the detection unit, i.e. being neighbored or adjacent to the detection unit. In other words, the detection unit may be arranged (for instance in direct contact or with a small gap) at least partially adjacent the end face so that the electromagnetic radiation which is coupled out of the tubing can directly impinge on the electromagnetic radiation sensitive portion of the detector. Such a configuration may allow to obtain a high signal-to-noise ratio.

The flow cell may comprise an electromagnetic radiation source configured for generating the electromagnetic radiation and for coupling the electromagnetic radiation into the lumen. Such an electromagnetic radiation source may be spatially arranged specifically at such a position that the direct coupling of emitted electromagnetic radiation into the tubing before having propagated at least partially through the lumen and therefore through the sample fluid is made impossible.

Still referring to the previously described embodiment, the electromagnetic radiation source may be configured for preventing coupling the electromagnetic radiation into the tubing before a propagation of the electromagnetic radiation through a part of the lumen. This can be achieved by positioning the electromagnetic radiation source to partially extend into the tubing, since this forces the electromagnetic radiation beam to at least partially propagate through the fluidic sample before entering the tubing.

A radiation coupler element, particularly an optical fiber piece such as a waveguide, may be provided and arranged for coupling the electromagnetic radiation from the electromagnetic radiation source into the lumen. In such a configuration, the electromagnetic radiation source may be arranged outside of the lumen which may be desired from a practical point of view. In such an embodiment, the optical fiber extending into the lumen can be used even in a miniaturized configuration and allows to artificially extend the effective spatial emitting position of the radiation beam into the lumen.

Still referring to the previously described embodiment, the radiation coupler element may spatially extend into the lumen. More precisely, an emitting end face of the optical coupler element may extend into the lumen to a further position within the fluidic path as compared to a front face of the tubing. This may safely prevent direct coupling of electromagnetic radiation into the tubing, which would be undesired since this would only contribute to the signal, not to the noise.

The electromagnetic radiation source may be configured for generating an optical light beam or an ultraviolet beam. An optical light beam may be a light beam of visible light, i.e. in a range between 400 nm and 800 nm. However, it is also possible to operate the system in the ultraviolet range or even in the infrared range. Other wavelength regimes are possible, such as X-rays or microwaves.

The electromagnetic radiation source may be a laser, a light emitting diode, a deuterium lamp, a tungsten lamp, a xenon lamp or the like. Such radiation sources are small in dimension, are capable of providing an intense radiation beam and are sufficiently cheap.

The detection unit may comprise an optical light detector or an ultraviolet radiation detector. The wavelength sensitivity of the detection unit may depend on the used electromagnetic radiation. Optionally, a wavelength selective optical element may be arranged between the electromagnetic radiation source and the detection unit such as a grating or the like. This may allow to spectrally split a beam into various wavelengths travelling through the lumen and/or the tubing.

The detection unit may comprise a single detection element such as a single photodiode. Alternatively, the detection unit may comprise a linear array of detection elements such as a linear straight arrangement of multiple photodiodes. It is also possible that a two-dimensional detector is used such as a CCD (Charge Coupled Device) or a CMOS (Complementary Metal Oxide Semiconductor) detector. The use of a detector having multiple detection elements may be advantageous since this may allow to separately evaluate the electromagnetic radiation having travelled through the lumen and the fluid entirely on the one hand, and the electromagnetic radiation having travelled partially through the lumen and partially through the tubing on the other hand. The latter electromagnetic radiation may have to be considered separately since its probe characteristic may differ from the formerly described electromagnetic radiation since it has only traversed the fluidic sample along a part of the propagation path.

The detection unit may be arranged to be located at the end face of the tubing and may spatially extend along at least a part of the, particularly along the entire, end face. In a hollow cylindrical configuration of the tubing, the end face (and preferably the corresponding detector area) may be an annulus. This may ensure that all light leaving the end face of the tubing may be used for the detection and the analysis of the sample.

Still referring to the previously described embodiment, the detection unit may be arranged to spatially extend along at least a part of an, particularly along an entire, end face of the lumen. Such a spatial arrangement may also ensure that all light leaving the end of the lumen is for the detection purposes as well, thereby further increasing the yield of electromagnetic radiation carrying sample information.

The flow cell may comprise a fluid inlet for introducing the sample fluid at or close to a front face of the tubing. Thus, the separated fluidic sample may be introduced in the flow cell near a front end of the tubing so that the whole extension of the lumen may be used for detecting purposes. The fluid outlet may also be provided for supplying the sample fluid via a recess in a lateral area of the tubing (particularly at a front portion thereof).

A fluid outlet may be foreseen for draining the sample fluid via a recess in a lateral area of the tubing (particularly at an end portion thereof). Thus, after having flown basically along the entire electromagnetic radiation interaction path of the flow cell, the fluid can leave the flow cell via a lateral recess such as a bore in a mantle surface of the tubular hollow cylindrical tubing. This has turned out as a powerful configuration for obtaining a high spatial range of an interaction between the electromagnetic radiation and the sample fluid and on the other hand an efficient fluidic coupling characteristic.

An evaluation unit may be provided which may be configured for evaluating an electromagnetic radiation signal detected by the detection unit. In other words, an output signal of the detection unit may be supplied to the evaluation unit. The evaluation unit may have processing capabilities and may be a microprocessor or a central processing unit such (CPU).

The evaluation unit may be configured for separately evaluating electromagnetic radiation propagating through the end face of the tubing between the inner wall and the outer wall and electromagnetic radiation propagating through an end face of the lumen. Since these two beams have a different history of propagating though the flow cell and consequently have experienced a different interaction with the sample, the separate evaluation of these partial beams may further refine and increase the accuracy of the detection. The evaluation unit may hence be further configured for evaluating the electromagnetic radiation propagating through the end face of the tubing between the inner wall and the outer wall considering that this electromagnetic radiation has partially propagated through the sample fluid and has partially propagated through the tubing between the inner wall and the outer wall. Using a model of the propagation of the partial beams, their information content may be retrieved more precisely. For instance, the amount of a sample signal contribution of the beam having partially travelled through the tubing may be smaller than a corresponding sample signal contribution in the portion having traversed the entire flow cell.

In an embodiment, the flow cell may be configured as a total internal reflection flow cell. Total internal reflection may be denoted as an optical phenomenon that occurs when a ray strikes a medium boundary at an angle larger than a critical angle with respect to the normal to the surface. If a corresponding angular condition is met and the refractive index is lower on the other side of the boundary no light can pass through, so effectively all of the light is reflected. A total internal reflection flow cell may make use of this effect and may be characterized by the fact that the whole electromagnetic radiation beam remains within the flow cell, since a total reflection occurs at the outer surface of the tubing. This keeps the entire amount of electromagnetic radiation within the tubing and the lumen and keeps the yield as high as possible.

The tubing and the electromagnetic radiation source may be arranged and configured for effecting a total reflection of the electromagnetic radiation at the outer wall. Thus, since total internal reflection depends on the refraction indices of the used materials as well as on the geometry, particularly the angular characteristic of the flow cell, the selection of geometry and materials are design parameters for adjusting the total reflection characteristic. Particularly, the refraction index of the material of the tubing should be higher than a refraction index of a surrounding material to obtain total reflection.

Moreover, the refraction index of the tubing may be higher than the refraction of water or the fluidic sample. For instance, the tubing may be made of silicon dioxide or glass. This may result in a total reflection at an outer surface of the tubing, not at an inner surface.

When at least partially embedding the tubing in a substrate, a proper selection of the materials of the substrate and the tubing may ensure that the phenomenon of total reflection may occur. Generally, the tubing should have a larger refraction index than the substrate to enable total reflection. However, the tubing may be made of silicon dioxide and the surrounding substrate may be made of silicon having a larger refraction index as compared to silicon dioxide. In such a scenario, silicon material can be optionally removed by etching or the like in a central portion only so that an outer surface of the tubing is surrounded by air (having a small refraction index) and end portions of the tubing are supported by silicon material as a holding frame. In the absence of a removal of silicon material, no total reflection will occur when light travels in the silicon dioxide tubing towards a border to the silicon, but a part of the light will still be reflected. The described alternatives may allow to monolithically integrate the flow cell in semiconductor technology.

To promote total reflection, it is also possible to line an outer lumen of the tubing with a layer of a material which ensures that total reflection can take place. The geometry according to an exemplary embodiment may have the advantage that a high optical path length of the electromagnetic radiation may be achieved and this may be combined efficiently with the provision of a high yield of the used electromagnetic radiation. Thus, particularly in view of the trend of a further miniaturization of flow cells, may allow to manufacture very small flow cells with a high accuracy. Even in the presence of shock noise which may occur with very small, long and thin capillaries in a flow cell, the system according to an exemplary embodiment may still allow to obtain a sufficiently high signal-to-noise ratio. According to an exemplary embodiment, also light travelling partially along the glass wall of the tubing which has seen the sample along a partial flow path can be used for evaluating an LC experiment and for determining information regarding the separated sample. Therefore, by extending the measurement also along a lateral extension of a glass capillary, the accuracy may be increased. This may require that the fluid is not coupled directly into the tubing but at least partially travels along the sample. Thus, the light may be coupled in the flow cell so that it does not directly travel into the tubing before having passed at least a portion of the fluid. The coupling of the light out of the flow cell can be performed such that the light leaving the end face of the tubing is detected.

In the following, further exemplary embodiments of the sample separation apparatus will be explained. However, these embodiments also apply to the flow cell and the method.

The sample separation apparatus may comprise a separation element filled with a separating material. Such a separating material which may also be denoted as a stationary phase may be any material which allows an adjustable degree of interaction with a sample so as to be capable of separating different components of such a sample. The separation element may be arranged in a fluidic path upstream the detector so that fractions of a sample separated by the separation element may be subsequently detected by the detector device.

The separating material may be a liquid chromatography column filling material or packing material comprising at least one of the group consisting of polystyrene, zeolite, polyvinylalcohol, polytetrafluorethylene, glass, polymeric powder, silicon dioxide, and silica gel, or any of above with chemically modified (coated, capped etc) surface. However, any packing material can be used which has material properties allowing an analyte passing through this material to be separated into different components, for instance due to different kinds of interactions or affinities between the packing material and fractions of the analyte.

At least a part of the separation element may be filled with a fluid separating material, wherein the fluid separating material may comprise beads having a size in the range of essentially 1 μm to essentially 50 μm. Thus, these beads may be small particles which may be filled inside the separation section of the microsample separation apparatus. The beads may have pores having a size in the range of essentially 0.01 μm to essentially 0.2 μm. The fluidic sample may be passed through the pores, wherein an interaction may occur between the fluidic sample and the pores.

The sample separation apparatus may be configured as a fluid separation system for separating components of the sample. When a mobile phase including a fluidic sample passes through the sample separation apparatus, for instance with a high pressure, the interaction between a filling of the column and the fluidic sample may allow for separating different components of the sample, as performed in a liquid chromatography device.

However, the sample separation apparatus may also be configured as a fluid purification system for purifying the fluidic sample. By spatially separating different fractions of the fluidic sample, a multi-component sample may be purified, for instance a protein solution. When a protein solution has been prepared in a biochemical lab, it may still comprise a plurality of components. If, for instance, only a single protein of this multi-component liquid is of interest, the sample may be forced to pass the column. Due to the different interaction of the different protein fractions with the filling of the column (for instance using a liquid chromatography device), the different samples may be distinguished, and one sample or band of material may be selectively isolated as a purified sample.

The sample separation apparatus may be configured to analyze at least one physical, chemical and/or biological parameter of at least one component of the mobile phase. The term “physical parameter” may particularly denote a size or a temperature of the fluid. The term “chemical parameter” may particularly denote a concentration of a fraction of the analyte, an affinity parameter, or the like. The term “biological parameter” may particularly denote a concentration of a protein, a gene or the like in a biochemical solution, a biological activity of a component, etc.

The sample separation apparatus may be implemented in different technical environments, like a sensor device, a test device, a device for chemical, biological and/or pharmaceutical analysis, or a liquid chromatography device. Particularly, the sample separation apparatus may be a High Performance Liquid device (HPLC) device by which different fractions of an analyte may be separated, examined and analyzed.

The sample separation apparatus may be configured to conduct the mobile phase through the system with a high pressure, for instance of 50 bar to 100 bar, particularly of at least 600 bar, more particularly of at least 1200 bar.

The sample separation apparatus may be configured as a microsample separation apparatus. The term “microsample separation apparatus” may particularly denote a sample separation apparatus as described herein which allows to convey fluid through microchannels having a dimension in the order of magnitude of less than 500 μm, particularly less than 200 μm, more particularly less than 100 μm or less than 50 μm or less.

Embodiments of the present invention might be embodied based on most conventionally available HPLC systems, such as the Agilent 1200 Series Rapid Resolution LC system or the Agilent 1100 HPLC series (both provided by the applicant Agilent Technologies—see www.agilent.com—which shall be incorporated herein by reference).

The separating device preferably comprises a chromatographic column (see e.g. http://en.wikipedia.org/wiki/Column chromatography) providing the stationary phase. The column might be a glass or steel tube (e.g. with a diameter from 50 μm to 5 mm and a length of 1 cm to 1 m) or a microfluidic column (as disclosed e.g. in EP 1577012 or the Agilent 1200 Series HPLC-Chip/MS System provided by the applicant Agilent Technologies, see e.g. http://www.chem.agilent.com/Scripts/PDS.asp?IPage=38308). For example, a slurry can be prepared with a powder of the stationary phase and then poured and pressed into the column. The individual components are retained by the stationary phase differently and separate from each other while they are propagating at different speeds through the column with the eluent. At the end of the column they elute one at a time. During the entire chromatography process the eluent might be also collected in a series of fractions. The stationary phase or adsorbent in column chromatography usually is a solid material. The most common stationary phase for column chromatography is silica gel, followed by alumina. Cellulose powder has often been used in the past. Also possible are ion exchange chromatography, reversed-phase chromatography (RP), affinity chromatography or expanded bed adsorption (EBA). The stationary phases are usually finely ground powders or gels and/or are microporous for an increased surface, though in EBA a fluidized bed is used.

The mobile phase (or eluent) can be either a pure solvent or a mixture of different solvents. It can be chosen e.g. to minimize the retention of the compounds of interest and/or the amount of mobile phase to run the chromatography. The mobile phase can also been chosen so that the different compounds can be separated effectively. The mobile phase might comprise an organic solvent like e.g. methanol or acetonitrile, often diluted with water. For gradient operation water and organic is delivered in separate bottles, from which the gradient pump delivers a programmed blend to the system. Other commonly used solvents may be isopropanol, THF, hexane, ethanol and/or any combination thereof or any combination of these with aforementioned solvents.

The sample fluid might comprise any type of process liquid, natural sample like juice, body fluids like plasma or it may be the result of a reaction like from a fermentation broth.

The HPLC system might further comprise a sampling unit for introducing the sample fluid into the mobile phase stream, a detector for detecting separated compounds of the sample fluid, a fractionating unit for outputting separated compounds of the sample fluid, or any combination thereof. Further details of HPLC system are disclosed with respect to the Agilent 1200 Series Rapid Resolution LC system or the Agilent 1100 HPLC series, both provided by the applicant Agilent Technologies, under www.agilent.com which shall be in cooperated herein by reference.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs. The illustration in the drawings is schematically.

FIG. 1 shows a liquid separation system in accordance with embodiments of the present invention, e.g. used in high performance liquid chromatography (HPLC).

FIG. 2 to FIG. 7 show flow cells in accordance with embodiments of the present invention, e.g. used in high performance liquid chromatography (HPLC).

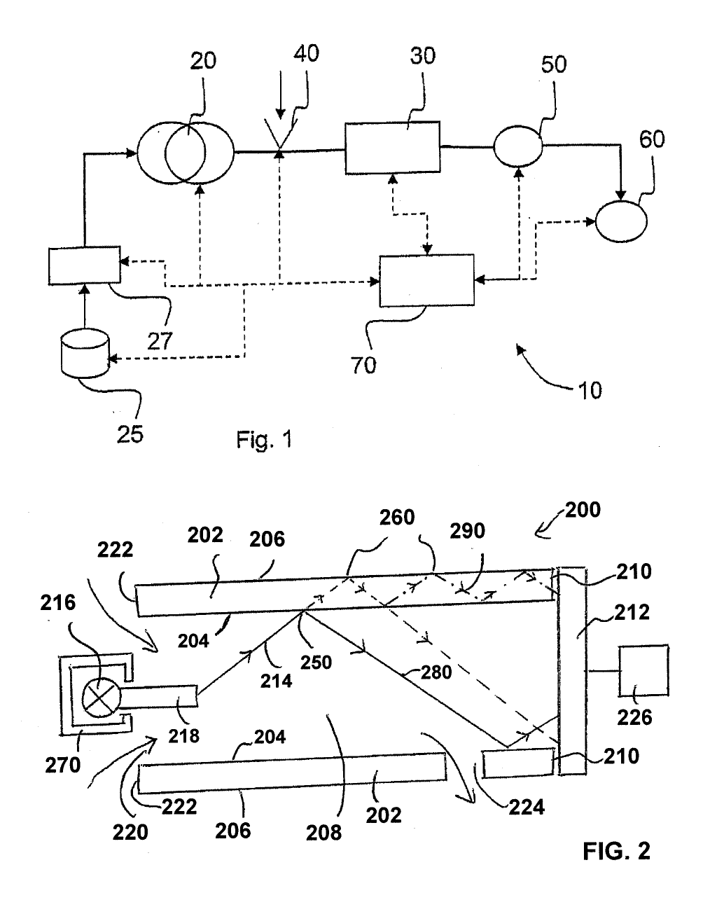

Referring now in greater detail to the drawings, FIG. 1 depicts a general schematic of a liquid separation system 10. A pump 20 receives a mobile phase from a solvent supply 25, typically via a degasser 27, which degases and thus reduces the amount of dissolved gases in the mobile phase. The pump 20—as a mobile phase drive—drives the mobile phase through a separating device 30 (such as a chromatographic column) comprising a stationary phase. A sampling unit 40 can be provided between the pump 20 and the separating device 30 in order to subject or add (often referred to as sample introduction) a sample fluid into the mobile phase. The stationary phase of the separating device 30 is configured for separating compounds of the sample liquid. A detector 50 is provided for detecting separated compounds of the sample fluid. A fractionating unit 60 can be provided for outputting separated compounds of sample fluid.

While the mobile phase can be comprised of one solvent only, it may also be mixed from plural solvents. Such mixing might be a low pressure mixing and provided upstream of the pump 20, so that the pump 20 already receives and pumps the mixed solvents as the mobile phase. Alternatively, the pump 20 might be comprised of plural individual pumping units, with plural of the pumping units each receiving and pumping a different solvent or mixture, so that the mixing of the mobile phase (as received by the separating device 30) occurs at high pressure and downstream of the pump 20 (or as part thereof). The composition (mixture) of the mobile phase may be kept constant over time, the so called isocratic mode, or varied over time, the so called gradient mode.

A data processing unit 70, which can be a conventional PC or workstation, might be coupled (as indicated by the dotted arrows) to one or more of the devices in the liquid separation system 10 in order to receive information and/or control operation. For example, the data processing unit 70 might control operation of the pump 20 (e.g. setting control parameters) and receive therefrom information regarding the actual working conditions (such as output pressure, flow rate, etc. at an outlet of the pump). The data processing unit 70 might also control operation of the solvent supply 25 (e.g. setting the solvent/s or solvent mixture to be supplied) and/or the degasser 27 (e.g. setting control parameters such as vacuum level) and might receive therefrom information regarding the actual working conditions (such as solvent composition supplied over time, flow rate, vacuum level, etc.). The data processing unit 70 might further control operation of the sampling unit 40 (e.g. controlling sample injection or synchronization sample injection with operating conditions of the pump 20). The separating device 30 might also be controlled by the data processing unit 70 (e.g. selecting a specific flow path or column, setting operation temperature, etc.), and send—in return—information (e.g. operating conditions) to the data processing unit 70. Accordingly, the detector 50 might be controlled by the data processing unit 70 (e.g.

with respect to spectral or wavelength settings, setting time constants, start/stop data acquisition), and send information (e.g. about the detected sample compounds) to the data processing unit 70. The data processing unit 70 might also control operation of the fractionating unit 60 (e.g. in conjunction with data received from the detector 50) and provides data back.

FIG. 2 illustrates a flow cell 200 for a sample separation apparatus 10 as shown in FIG. 1 for separating components of a sample fluid in the mobile phase. Flow cell 200 may form or may form part of the detector 50.

The flow cell 200 is configured for detecting the components separated by the separation column 30 and comprises a glass tubing 202 having an inner wall 204 and an outer wall 206 in a hollow cylindrical configuration. The inner wall 204 delimits a fluidic lumen 208 within which the sample fluid is to be conducted. The tubing 202 has an end face 210 which may have a planar annular end surface.

A photodetector 212 configured for detecting light 214 exiting the end face 210 after propagation of the light beam 214 through the sample fluid in a portion of the lumen 208 and through a portion of the tubing 202 between the inner wall 204 and the outer wall 206 is provided as well.

As can be taken from FIG. 2, the light beam 214 can be partially reflected at a position 250 at which the fluidic lumen 208 abuts to the inner wall 204 of the glass tubing 202. Due to the refraction indices of the aqueous solution in the lumen 208 and the refraction index of the glass tubing 202, a partial reflection may occur at position 250.

In contrast to this, due to the selected refraction indices, total reflection indicated schematically with reference numeral 260 may occur at the outer wall 206 so that all the light 214 remains with the flow cell 200.

According to an exemplary embodiment, not only the light beam 280 travelling entirely through the lumen 208 impinges on the light sensitive surface of the detector 212, but also light 290 having made a total reflection 260 at the tubing 202, exiting via the end face 210 and abutting on the light sensitive surface of the detector 212 arranged to face this end face 210. Since also the totally reflected radiation 260 has seen the sample before entering the tubing 202, also this light contains information indicative of components of the sample which can be used according to an exemplary embodiment. During the propagation of the light 214 through the sample, wave-matter interaction may happen so that the light is influenced in its characteristics by this interaction and therefore carries information indicative of sample properties. After a total reflection of light beam 290 at a position 260, not the entire intensity of this light beam will remain within the wall 202 but may be partially transmitted back (according to the Fresnel equations) into the lumen 208 at a border between the lumen 208 and the wall 202. Such effects are not shown in the figure for the sake of simplicity.

A light source 216 generates the light beam 214 and couples the light beam 214 into the lumen 208. The light beam 216 is surrounded by an absorbing element 270 which prevents that light 214 is directly coupled into the front face 222 of the tubing 202 before having travelled along a section of the lumen 208. Such light would not contain any additional sample information and only contributes to the noise, not to the signal. The proper coupling of the light 214 into the lumen 208 at a proper position involves an optical fiber piece 218 which is arranged to extend into the lumen 208 to thereby prevent coupling of the light directly in the front face 222 of the tubing 208. The sample fluid originating from the separation column 30 enters the flow cell 200 through a fluid inlet 220 at the front face 222 of the tubing 202. After having flown along the entire lumen 208, the fluidic sample is drained via a recess or fluid outlet 224 in a lateral surface of the hollow cylindrical tubing 202. An evaluation unit 226 is communicatively coupled with the detection unit 212 for evaluating the light signal detected by the detection unit 212 and for outputting information indicative of the fractions of the sample under investigation. The flow cell 200 is a total internal reflection flow cell.

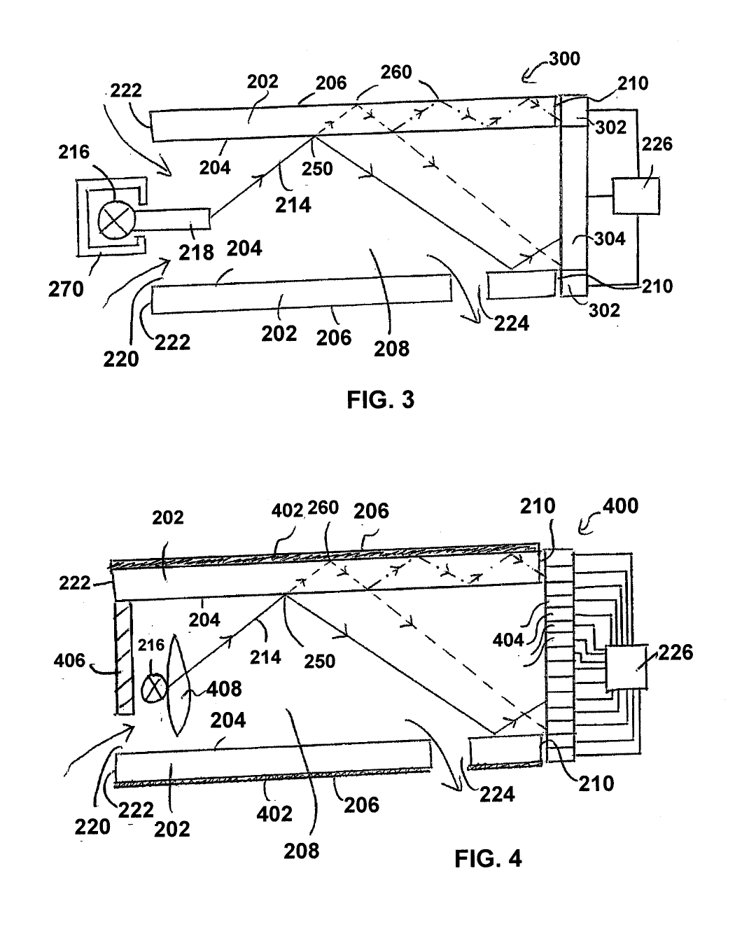

In a flow cell 300 shown in FIG. 3 according to another embodiment, the detection unit is separated into a central portion 304 spatially arranged to capture light 214 exiting through the lumen 208 and an outer or surrounding portion 302 selectively detecting light 214 having travelled partially through the lumen 208 but also partially through the tubing 202. Since the latter light has only seen the sample along a portion of the lumen 208, its separate evaluation may further increase the reliability of the detection result.

In a flow cell 400 shown in FIG. 4 according to another embodiment, a light reflection layer 402 is provided at the outer wall 206 of the tubing 202 which guarantees total internal reflection due to appropriately selected refraction indices. In this embodiment, the detection element is separated into a plurality of different pixels 404 each of which supplying a separate detection signal to the evaluation unit 226 for separate evaluation. Such a spatially resolved detection may provide more accurate results. This may further refine the detected information, since the spatial position also has an impact on the effective path length of the sample which the corresponding light portion has seen after propagating through the flow cell 400.

Furthermore, no optical fiber piece 218 is provided in FIG. 4. To prevent that the light 214 from the light source 216 is directly coupled into the front face 222 of the tubing 202, an aperture element 406 is provided to shield a corresponding front area. Furthermore, one or more lenses 408 may be arranged between the light source 216 and the detector 404 so as to define an angular range over which the light 214 is coupled into the lumen 208.

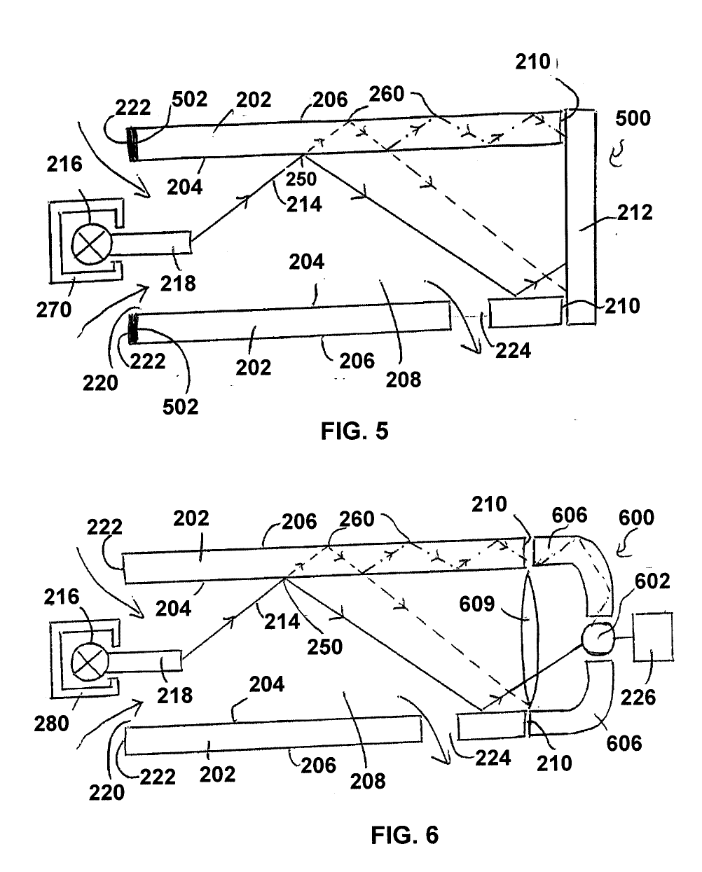

In a flow cell 500 according to another embodiment shown in FIG. 5, the front face 222 of the tubing 202 is provided with a blackened surface 502 which further prevents the coupling of ambient light or the like into the tubing which might deteriorate the detection performance.

In a flow cell 600 according to another embodiment shown in FIG. 6, a single light detection element 602 such as a photodiode is provided for detecting the entire light. For bundling the light travelling entirely through the lumen 208, a corresponding lens 604 is provided. Furthermore, optical fiber pieces 606 are arranged between the end face 212 of the tubing 202 on the one hand and the photo detector 602 on the other hand. Through these coupling elements 606, the light exiting via the end face 210 is directed onto the detector 602 for detection.

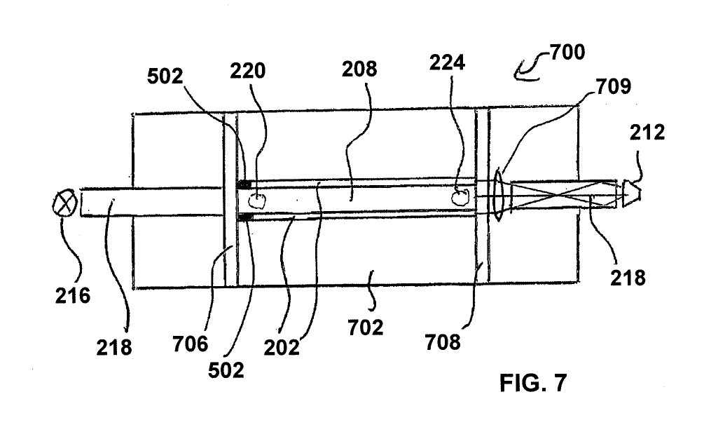

FIG. 7 shows a monolithically integrated flow cell 700 according to another exemplary embodiment. Here, the tubing 202 is formed as an oxidized surface portion within a silicon substrate 702. Thus, a fluidic conduit 208 is formed. The silicon oxide tubing 202 is embedded in the semiconductor substrate 702. In FIG. 7, two optical elements 218 are provided, one between the light source 216 and the lumen 208 and the other one between the lumen 208 and the detector 212. In the shown configuration, the blackened portion 502 prevents entry of light from the light source 216 directly into the tubing 202 before having propagated partially along the lumen 208. A lens 704 ensures that also the light having partially travelled through the lumen 202 is detected by the detector 212.

An optically transparent first end plate 706 and an optically transparent second end plate 708 are provided as well.

In FIG. 7, lens 704 is optional, for instance in a configuration in which a diameter of fiber 218 is larger than a diameter of the capillary 202. Accordingly, reference numeral 218 may be substituted by a lens, a mirror or any other appropriate optical element. Advantageously, air or any other gas, vacuum, or an appropriate coating may be arranged between reference numerals 202 and 702. It may be advantageous that a refraction index of such a material is smaller than a refraction index of a solvent such as water.

It should be noted that the term “comprising” does not exclude other elements or features and the “a” or “an” does not exclude a plurality. Also elements described in association with different embodiments may be combined. It should also be noted that reference signs in the claims shall not be construed as limiting the scope of the claims.

1. A flow cell for a sample separation apparatus for separating components of a sample fluid in a mobile phase, the flow cell being configured for detecting the separated components and comprising:
a tubing having an inner wall and an outer wall, the inner wall defining a lumen for conducting the sample fluid, the tubing further having at one end an end face; and
a detection unit configured for detecting electromagnetic radiation exiting the end face after propagation of the electromagnetic radiation through the sample fluid in a portion of the lumen and through a portion of the tubing between the inner wall and the outer wall.

2. The flow cell according to claim 1,
wherein the detection unit is configured for additionally detecting electromagnetic radiation after propagation entirely through the sample fluid in the lumen without propagating through the tubing between the inner wall and the outer wall.

3. The flow cell according to claim 1,
wherein the detection unit is configured for detecting the electromagnetic radiation after propagation partly through the sample fluid in the lumen and partly through the tubing and exiting via the end face of the tubing between the inner wall and the outer wall, the end face facing the detection unit.

4. The flow cell according to claim 1,
wherein the detection unit is configured for detecting the electromagnetic radiation after propagation partly through the sample fluid in the lumen and partly through the tubing and exiting via the end face of the tubing between the inner wall and the outer wall, the end face being arranged at a fluid outlet downstream a fluid inlet.

5. The flow cell according to claim 1,
further comprising an electromagnetic radiation source configured for generating the electromagnetic radiation and for coupling the electromagnetic radiation into the lumen.

6. The flow cell according to claim 5,
wherein the electromagnetic radiation source is located for preventing coupling the electromagnetic radiation into the tubing before a propagation of the electromagnetic radiation through a part of the lumen.

7. The flow cell according to claim 5,
further comprising a radiation coupler element, arranged for coupling the electromagnetic radiation from the electromagnetic radiation source into the lumen.

8. The flow cell according to claim 7,
wherein the radiation coupler element spatially extends into the lumen.

9. The flow cell according to claim 5,
wherein the electromagnetic radiation source is configured for generating one of an optical light beam and an ultraviolet beam.

10. (canceled)

11. (canceled)

12. (canceled)

13. The flow cell according to claim 1,
wherein the detection unit is arranged to spatially extend along at least a part of the end face or along the entire end face.

14. The flow cell according to claim 13,
wherein the detection unit is arranged to spatially extend along at least a part of an end face of the lumen or along an entire end face of the lumen.

15. (canceled)

16. The flow cell according to claim 1,
comprising a fluid outlet for draining the sample fluid via a recess in a lateral area of the tubing.

17. The flow cell according to claim 1,
further comprising an evaluation unit configured for evaluating an electromagnetic radiation signal detected by the detection unit.

18. The flow cell according to claim 17,
wherein the evaluation unit is configured for separately evaluating electromagnetic radiation propagating through the end face of the tubing between the inner wall and the outer wall and electromagnetic radiation propagating through an end face of the lumen.

19. The flow cell according to claim 18,
wherein the evaluation unit is configured for evaluating the electromagnetic radiation propagating through the end face of the tubing between the inner wall and the outer wall under consideration for the evaluation that this electromagnetic radiation has partially propagated through the sample fluid and has partially propagated through the tubing between the inner wall and the outer wall.

20. The flow cell according to claim 1,
configured as a total internal reflection flow cell.

21. The flow cell according to claim 5,
wherein the tubing and the electromagnetic radiation source are arranged and configured for effecting a total reflection of the electromagnetic radiation at the outer wall.

22. The flow cell according to claim 1,
wherein the end face is annularly shaped.

23. (canceled)

24. A sample separation apparatus for separating components of a sample fluid in a mobile phase, the sample separation apparatus comprising:
a separation unit configured for separating the sample fluid into the components; and
a flow cell according to claim 1 or any one of the above claims in fluid communication with the separation unit for receiving the separated sample fluid from the separation unit and configured for detecting the separated components.

25. (canceled)

26. A method of detecting separated components of a sample fluid in a mobile phase, the method comprising:
conducting the separated sample fluid through a lumen of a flow cell comprising a tubing having an inner wall and an outer wall, the inner wall defining the lumen, the tubing further having at one end an end face; and
detecting electromagnetic radiation exiting the end face after propagation of the electromagnetic radiation through the sample fluid in a portion of the lumen and through a portion of the tubing between the inner wall and the outer wall.
